(19) United States
(12) Patent Application Publication
(10) Pub. No.: US 2024/0008392 A1
(43) Pub. Date: Jan. 11, 2024

(54) SEED COATING COMPOSITION, COATED SEED, SEED COATING METHOD AND A SOWING PROCESS

(71) Applicant: Singularity Ag International IncM, Lewes, DE (US)

(72) Inventors: Federico Eduardo Cola, Rio Cuarto (AR); Alvaro Marcos Fernandez, Rio Cuarto (AR)

(21) Appl. No.: 18/348,555

(22) Filed: Jul. 7, 2023

Related U.S. Application Data
(60) Provisional application No. 63/367,866, filed on Jul. 7, 2022.

(51) Int. Cl. A01C 1/06; A01C 7/00

(52) U.S. Cl. CPC A01C 1/06; A01C 7/00

(57) ABSTRACT

A composition and a pelleted seed, and a coating process for preparing the coated seeds by utilizing inexpensive materias such as PVA, activated carbon and microcrystalline cellulose in a specific composition range, which greatly reduces spatial variability, achieving uniform plant stands, and reduces the emergence variability without significantly hindering the development of the seedling, achieving uniformly early emerged plants. The pelleted seeds exhibit an outstanding tolerance to cold and hydric stress conditions after sowing, preserving the vitality of seeds.

### CROSS-REFERENCE TO RELATED APPLICATION

This application claims the benefit of priority from U.S. Provisional Patent Application No. 63/367,866, filed Jul. 7, 2022, the contents of which is incorporated herein by reference.

### FIELD OF THE INVENTION

The invention belongs to the technical field of agricultural planting, and relates to coated seeds suitable for direct seeding, no-till farming, direct planting and a coating process thereof.

### STATE OF THE ART

It is known that in current sowing and cultivation techniques, the distance between plant rows and distance between each plant within the same row are important parameters to consider to maximize crop yield. In this vein, if there are two plants very close to each other, they would compete for nutrients, affecting their development. On the other hand, very distant plants imply waste of cultivable soil (Satorre; 2021). For this reason, specialized high-precision sowing machinery is nowadays used to ensure that a certain number of seeds is accurately planted into the soil at a certain depth and distance. However, due to the design of the different sowing and seed handling machines, as well as the inherent shape, size, weight and size distribution of certain species, can generate problems of variability in the spacing between plants and inadequate number of seeds per position in each row.

The degree of variability in emergence, or temporal variability, is another fundamental variable that can be quantified through the variability in the phenology of plants after the end of the emergence process and/or the proportion of late plants with a difference in n expanded leaves compared to early-emerging plants (Liu et al.; 1996). Both spatial and temporal non-uniformity are particularly important for the corn crop, since it does not have a great capacity to compensate for a deficit in plant stand.

In addition, sowing of corn seeds is usually done during the spring months when the weather conditions are changing and are often unfavorable. In this vein, the period when there are optimal meteorological conditions, which are also appropriate for preserving the vitality of seeds, i.e. temperatures over 8° C. and humidity around 13-16%, is too short. When sowing is conducted at temperatures lower than 8° C. and high humidity, there is a risk of sowing failure.

Corn is a cereal of particular interest due to its great importance worldwide in the food and biofuels industries. It represents one of the highest percentages of revenue in the international cereal market. However, the intrinsic morphology and size distribution of corn seeds affects the filling efficiency of a perforated plate at the time of sowing, reducing the overall efficiency of the entire process and generating great economic losses every year.

In the case of alfalfa and some other large-scale sown pastures, the mechanical seed dosers generally used are not able to effectively control the seeding density (seeds/m 2) due to the very low seed weight of these species.

In the case of vegetables with high commercial seed cost, such as lettuce and celery; a common culture practice consists in sowing the seeds in cell germination trays and then transferring the seedlings to the fields. This technique frequently employs vacuum systems that take a single seed and drop it into the corresponding cell. However, this process is very inefficient due to the very low weight and irregular morphology.

To mitigate the lack of homogeneity among seeds, seed providers usually select and calibrate seeds in size and shape. Although this improves the sowing efficiency of irregularly shaped seeds, it does not completely solve the problem, nor does it solve the problems associated with very small and light seeds.

Consequently, great effort has been made to develop a coating technology to be applied to the seeds in order to obtain bigger, more homogeneous and easier to manipulate seed batches. In this regard, different kinds of seed coating can be classified according to the amount of external material added. For example, in encrusted seeds, the amount of added material is such that the weight and volume of the seed is noticeably increased, but the shape of the original seed is still recognizable. On the other hand, pelleted seeds have been coated with enough material to provide them a spherical or quasi-spherical shape; the main objective of pelleting seeds is to obtain a narrow pellet size and weight distribution. Another advantage of seed coating is the ability to incorporate controlled amounts of agriculturally active ingredients (fertilizers, inoculants, insecticides, fungicides, etc.) into the coatings, according to the nutritional needs of the soil and microorganisms, insects and weeds present in each farming area.

In this vein, several documents disclosing coated seeds as a solution to these problems can be found in the state of the art. An example is document CN1137615 C which describes a process for making corn seed balls wherein corn seeds are first selected and placed in a rotary machine to be then sprayed with a certain amount of binder followed by the addition of bentonite powder; then are left idling for a period of time and later more binder and bentonite powder are added alternatively to obtain corn seed balls.

Another example is disclosed in patent CN103069950 B wherein a method of pelleting eurya emarginata seeds is provided comprising the stages of placing clean eurya emarginata seeds in a rotary pelletizer, spraying a coating agent, adding a mixed powder, repeating the stages at an interval of 20-60 s to allow the eurya emarginata seeds to be coated, spraying a warning coloring solution for dyeing, removing them, drying and packaging. This method is used to increase the size and weight of the seeds to facilitate sowing with precision machines. The method also allows the incorporation of additives to the coating to promote seed growth.

Likewise, the TWI676413 B patent provides a process for producing coated granulated seed comprising the steps of applying a binder to seed grains and adding a coating composition comprising silica. The invention furthermore relates to the use of silica as a component of the coating layer of granulated seed for improving the germination capacity of the seed.

On the other hand, application US20100263274 A1 describes encapsulated seed articles and a method for making them comprising a compressible encapsulation medium, which in turn comprises additives, which is pressed around the seed to form the encapsulated seed article, being possible to adjust the shape and size of said encapsulated seed article.

However, these coatings can present a series of disadvantages such as high cost, coating fragility and dust generation, decrease of germination capacity and germination energy due to physical hindering or chemical affectation of the seeds, among others. For this reason, the use of pelleted seed has not been widely adopted worldwide as a solution to plantability problems of seeds with small size, light weight, and/or irregular morphology.

Therefore, there is still a need to provide a pelleted seed that solves the aforementioned problems and that the technology to produce them can be easily adopted by farmers and seed providers.

The present invention provides a composition and a pelleted seed, wick is very simple and utilizes inexpensive materias such as PVA, activated carbon and microcrystalline cellulose in a specific composition range that, surprisingly, not only greatly reduces spatial variability, achieving uniform plant stands, but also reduces the emergence variability without significantly hindering the development of the seedling, achieving uniformly early emerged plants. In addition, the pelleted seeds of the present invention, unexpectedely, exhibit an outstanding tolerance to cold and hydric stress conditions after sowing, preserving the vitality of seeds.

### BRIEF DESCRIPTION OF THE INVENTION

In one embodiment, the present invention is a seed coating composition or a seed capsule composition, to be applied to the external surface of a seed forming a layer of material around it, wherein said seed coating composition comprises at least a binder and a filler. Wherein said binder is selected from the group that comprises, but is not limited to: poly vinyl alcohol (PVA), carboxymethyl cellulose (CMC), hydroxypropyl methylcellulose (HPMC), polyvinylpyrrolidone (PVP), xanthan gum, arabic gum, and combinations thereof. And wherein said filler is selected from the group that comprises, but is not limited to: peat, microcrystalline cellulose, carbon, activated carbon, diatomite, bentonite, red clay, kaolin, fumed silica, expanded silica, cellulose, lignocellulose, Dried Distillers Grains (DDG), Wet Distillers Grains (WDG), and combinations thereof.

In another embodiment, said seed coating composition to be applied to the external surface of a seed forming a layer of material around it, comprises microcrystalline cellulose, activated carbon, poly vinyl alcohol (PVA) and mixtures thereof.

In another embodiment of the present invention, said coating composition comprises: from 1% to 7% PVA; from 27.5% to 60% microcrystalline cellulose; and from 37.5% to 70% activated carbon.

In another embodiment of the present invention, said coating composition comprises: from 2 to 3.5% PVA; from 33% to 50% microcrystalline cellulose; and from 47% to 64% activated carbon.

In another embodiment of the present invention, said seed coating composition is 2.5% PVA, 38% microcrystalline cellulose and 59.5% activated carbon.

In another embodiment of the present invention, said seed coating composition further comprises an agriculturally active ingredient. Wherein, said agriculturally active ingredient is selected from the group consisting in fertilizers, pesticides, fungicides, synergists, plant growth regulators, biostimulants, herbicides, and combinations thereof.

In another embodiment of the present invention, said seed coating composition further comprises a dye and/or a surface modifier.

Another embodiment of present invention is a coated seed (pelleted seed o encapsulated seed) suitable for its use in sowing techniques, wherein said coated seed comprises at least one seed and is coated with the seed coating composition of the invention.

In another embodiment of the present invention, said seed is selected from the group of plant species comprising, but not limited to, Beta vulgaris, Malpighia emarginata, Cichorium intybus L., Cyclanthera pedata, Vigna angularis, Agave spp., Agropyron elongatum, Agropyron scabrifolium, Agropyron cristatum, Agropyron desertorum, Agropyron intermedium, Agropyron trichoforum, Agrostis stolonifera, Physalis peruviana, Satureja montana, Artemisia absinthium, Capsicum baccatum, Pachyrhizus ahipa, Allium sativum, Allium ampeloprasum complex, Populus spp., Ocimun basilicum, Capparis Spinosa, Cynara scolymus, Cucurbita ficifolia, Medicago sativa, Lotus uliginosus, Gossypium albiflorum, Dipteryx oleifera, Phalaris canariensis, Ananas comosus, Cucurbita moschata, Angelica archangelica, Pimpinella anisum, Anthephora pubescens, Alstroemeria spp., Amaranthus hypochondriacus, Apium graveolens, Arachis pintoi, Vaccinium spp., Chrysalidocarpus Lutescens, Oryza sativa, Pisum sativum, Euterpe oleracea, Aleurites moluccana, Avena sativa, Avena byzantina, Avena sativa, Avena strigosa, Crocus sativus, Lilium longiflorum, Ziziphus Jujuba, Abelmoschus esculentus, Musa×paradisiaca, Ipomoea batatas, Adansonia digitata, Solanum melongera, Citrus bergamia, Ranunculus acris, Brachiaria ruziziensis, Urochloa brizantha, Brachiaria hibrida, Brassica forrajera rape, Brassica oleracea var. italica, Bromus valdivianus Phil., Bromus parodi, Bromus perenne, Cenchrus ciliaris, Butia capitata, Nasturtium officinale, Theobroma cacao L., Coffea arabica, Cucurbita maxima, Cucurbita argyrosperma, Berberis microphylla, Calibrachoa spp., Brassica napus, Saccharum officinarum, Cannabis sativa, Averrhoa carambola, Silybum marianum, Carthamus tinctorius, Castanea sativa, Vigna unguiculata, Cucurbita ficifolia, Hordeum vulgare, Hordeum distichum, Hordeum hexastichon, Bromus catharticus, Bromus unioloides, Bromus auleticus, Bromus inermis, Bromus unioloides var., Bromus brevis Ness, Bromus inermis, Allium cepa, Allium fistulosum L., Allium schoenoprasum, Aloysia citrodora, Secale cereale, Prunus subg. Cerasus, Cynodon dactylon, Allium ascalonicum, Salvia hispanica, Annona cherimola, Nierembergia linariifolia, Cyperus esculentus, Prunus domestica, Prunus salicina, Cymbopogon nardus, Citrus spp., Cocos nucifera L, Brassica oleracea var. gemmifera, Brassica oleracea var. botrytis, Brassica napus, Cuminum cyminum, Coriandrum sativum, Curcuma longa, Curcuma domestica, Prunus armeniaca, Phoenix dactylifera, Desmanthus acuminatus, Desmodium ascendens, Dichanthium aristatum, Digitaria sanguinalis, Dolichos lablab, Ilex dumosa, Prunus persica, Anethum graveolens, Cichorium endivia, Eragrostis curvula, Digitalis purpurea, Cichorium endivia, Asparagus officinalis, Spinacia oleracea, Stevia rebaudiana, Artemisia dracunculus, Eucalyptus spp., Phalaris aquatica, Acca sellowiana, Trigonella foenum-graecum, Festuca arundinacea, Festuca rubra, Lolium multiflorum×Festuca pratensis, Ficus spp., Photinia spp., Rubus idaeus, Arrhenatherum elatius, Fragaria spp., Cicer arietinum, Helianthus annus, Helianthus spp., Glandularia peruviana, Chloris gayana, Punica granatum, Ribes uva-crispa, Ribes nigrum, Ribes rubrum, Tecoma stans, Psidium spp. Prunus cerasus, Gypsophila spp. Vicia faba, Ficus carica, Salix×argentinensis, Foeniculum vulgare, Hyssopus officinalis, Artocarpus heterophyllus, Jatropha spp., Zingiber officinalis, Simmondsia chinensis, Brassica oleracea var. sabellica L., Diospyros kaki, Panicum coloratum, Pennisetum Purpureum×Pennisetum Typhoides, Pennisetum clandestinum, Actinidia deliciosa, Amaranthus caudatus, Fortunella spp. Handroanthus heptaphyllus, Cordia alliodora, Lavandula latifolia, Lactuca sativa, Cymbopogon citratus, Lens culinaris, Lespedeza capitata, Leucaena leucocephala, Litchi chinensis, Citrus aurantifolia, Citrus×aurantifolia, Citrus limetta, Citrus limon, Linum usitatissimum, Alisma plantago-aquatica, Lotononis bainesii, Solanum quitoense, Lupinus angustifolius, Humulus lupulus, Zea mays, Melicocca bijuga, Citrus reticulata, Manihot esculenta, Mangifera indica, Arachis hypogaea, Matricaria chamomilla, Malus domestica, Passiflora edulis, Tropaeolum tuberosum, Mecardonia procumbens, Medicago littoralis, Medicago polymorpha, Medicago scutellata, Medicago truncatula, Melilotus officinalis, Melilotus albus, Melilotus altissimus, Melilotus indicus, Cucumis melo, Gustavia superba, Mentha piperita, Panicum miliaceum, Panicum coloratum, Pennisetum glaucum, Salix viminalis, Salix caprea, Setaria italica, Brassica alba, Sinapis alba, Brassica carinata, Rubus fruticosus, Brassica juncea, Ugni molinae, Brassica campestris, Brassica rapa, Brassica napus subsp. napus, Citrus sinensis, Citrus×aurantium, Citrus×sinensis, Prunus persica var. nucipersica, Juglans regia, Macadamia integrifolia, Carya illinoinensis, Manilkara zapota, Oxalis tuberosa, Abelmoschus esculentus, Hibiscus esculentus, Olea europaea, Origanum vulgare, Cymbopogon martini, Persea americana, Panicum maximun, Panicum antidotale, Solanum tuberosum, Sechium edule, Carica papaya, Paspalum atratum, Hemarthria altissima, Pennisetum purpureum, Cynodon nlemfuensis, Megathyrsus maximus, Paspalum notatum, Axonopus catarinensis, Eragrostis curvula, Acroceras macrum, Paspalum dilatatum, Dactylis glomerata, Digitaria eriantha, Paspalum guenoarum Arechay. var. guenoarum var guenoarum, Paspalum guenoarum Arechay. var. rojasii (Hack.) Parodi var. rojasii, Dactylis glomerata, Asimina triloba, Carya illinoinensis, Minthostachys verticillata, Cucumis sativus, Pyrus communis, Pyrus pyrifolia, Petroselinum crispum, Petroselinum hortense, Petunia spp., Phalaris angusta, Phalaris aquatica, Phalaris bulbosa, Phalaris tuberinacea, Piper nigrum, Sanguisorba minor, Pistacia vera, Selenicereus undatus, Calliandra spp., Poa annua, Poa pratensis, Poa annua var. reptans, Citrus grandis, Phaseolus vulgaris, Vigna angularis, Lablab purpureus, Vigna radiata, Phaseolus lunatus, Allium porrum, Chenopodium quinoa, Fortunella spp., Raphanus sativus, Lolium multiflorum, Lolium hybridum, Lolium perenne, Nephelium lappaceum, Beta vulgaris, Brassica oleracea, Brassica rapa pekinensis, Beta vulgaris var. rubra, Beta rubra, Ricinus communis, Brassica oleracea var. capitata, Rosa spp., Brassica oleracea var gemmifera, Ruta spp., Lolium multiflorum, Lolium perenne, Lolium persicum, Rosa sp., Salvia greggii, Citrullus vulgaris, Salix humboldtiana, Salix nigra, Salix babylonica, Salix alba, Sambucus canadensis, Lespedeza cuneata, Lespedeza cuneata, Camelina sativa, Setaria spp., Setaria viridis, Setaria sphacelata, Setaria faberi, Setaria parviflora, Macroptilium atropurpureum, Glycine max, Neonotonia wightii, sin. Glycine javanica, Sorghum. bicolor, Sorghum saccharatum, Sorghum bicolor, Sorghum×drummondii, Sorghum almum, Stevia rebaudiana, Stylosanthes spp., Tagetes minuta, Nicotiana tabacum, Tamarindus indica, Citrus×tangelo, Colocasia esculenta, Euphorbia lathyris, Camellia sinensis, Tetracne spp., Lycopersicon esculentum, Thymus vulgaris, Helianthus tuberosus, Citrus medica, Lotus tenuis, Trifolium repens, Trifolium alexandrinum, Lotus corniculatus, Melilotus albus Medik, Trifolium incarnatum, Trifolium fragiferum, Trifolium resupinatum, Trifolium pratense, Lotus glaber, Lotus subbiblorus, Triticale×trigopiro, Triticum sp., Triticum spelta, Triticum durum, Triticum aestivum, Fagopyrum esculentum, Thinopyrum elongatum, xTriticosecale, Opuntia ficus-indica, Vernicia fordii, Tulipa spp., Ullucus tuberosus, Vanilla planifolia, Chrysopogon zizanioides, Vicia benghalensis, Vicia dasycarpa, Vicia faba, Vicia pannonica, Vicia villosa, Vitis vinifera, Smallanthus sonchifolius, Ilex paraguariensis, Daucus carota, Cucurbita maxima, Cucurbita maxima var. zapallito, Rubus ulmifolius, Zoysia spp., and Cucurbita pepo. Preferably said coated seed comprises corn (Zea mays) seeds.

In another embodiment of the present invention, said coated seed comprises pelleted seeds and encrusted seeds.

Another embodiment of the present invention is a coating process for preparing coated seeds in a drum with a rotating plate, wherein it comprises the steps of:
a. wetting the seeds with a liquid for at least 1 second,
b. waiting for at least 2 seconds,
c. adding the solids for at least 2 seconds,
d. waiting for at least 1 second,
e. repeating steps a. to d. until the seeds gained the desired mass and shape,
f. sieving the seeds to classify them by size,
g. drying the seeds.

Wherein, preferably, said plate spins at a speed between 50 and 2500 rpm; and preferably, the inclination angle between the axis of said cylinder with a bottom plate and the vertical axis is from 0° to 90°. Wherein said liquid comprises a 5% in water PVA solution. Wherein said solid comprises a mixture of microcrystalline cellulose and activated carbon in a microcrystalline cellulose:activated carbon mass ratio selected from the range from 0.3 to 1.6. Preferably 0.6.

Other embodiment of the present invention is a sowing process that uses the coated seeds of the invention and it comprises the following steps:
a. providing the coated seeds to the sowing machine;
b. setting the sowing machine to work with the coated seeds, taking into consideration size and shape;
c. opening a furrow in the soil;
d. inserting the coated seeds into said furrow;
e. covering the furrows with soil.

Another embodiment of the present invention is an encapsulated seed suitable for its use in sowing techniques, wherein said encapsulated seed comprises a seed and the seed capsule composition of the invention.

### BRIEF DESCRIPTION OF THE FIGURES

FIG. 1. Pelleted Seeds with different activated carbon to microcrystalline cellulose ratios, formulas 1 to 5.

FIG. 2. Germination Energy and Germination Capacity as a function of the activated carbon percentage.

FIG. 3. Average root length as a function of the activated carbon percentage.

FIG. 4. (a) Cumulative number of seedlings emerged over time under normal test conditions. (b) Number of seedlings emerged each day under normal test conditions.

FIG. 5. (a) Cumulative number of seedlings emerged over time under cold test conditions. (b) Number of seedlings emerged each day under cold test conditions.

FIG. 6. (a) Cumulative number of seedlings emerged over time under hydric stress conditions. (b) Number of seedlings emerged each day under hydric stress conditions.

FIG. 7. Percentage of plants emerged as a function of time exposed to room temperature after 5 days of exposure to low temperatures for pelleted seeds and control seeds.

FIG. 8. Percentage of plants emerged as a function of time exposed to room temperature after 7 days of exposure to low temperatures for pelleted seeds and control seeds.

FIG. 9. Percentage of plants emerged as a function of time exposed to room temperature after 9 days of exposure to low temperatures for pelleted seeds and control seeds.

FIG. 10. Average plant height as a function of exposure time to low temperatures for pelleted seeds and control seeds.

FIG. 11. Average root length as a function of exposure time to low temperatures for pelleted seeds and control seeds.

FIG. 12. Schematic representation of the sampling experimental unit distribution (3 meters length) along the planting rows.

### DETAILED DESCRIPTION OF THE INVENTION

The present invention solves the problems of the state-of-the-art encrusted and pelleted seeds providing an environmentally friendly, high stability, and inexpensive seed coating composition, a coated seed, and a coating process for preparing coated seeds suitable for conventional and precision sowing techniques. Thus, the seed coating composition of the present invention, when applied to seeds, can improve plantability of irregular-shaped or very small and light seeds without noticeably affecting their germination capacity and germination energy, which translates into a significant improvement in yields at the time of harvest. The seed coating composition of the present invention also protects the seed from hydric stress and extremely cold temperatures, improving the emergence of the seed that suffered low soil water availability periods and allowing the early sowing of some species like corn, as will be exemplified in this document. In addition, under all circumstances tested, i.e. normal tests, cold tests, and hydric stress tests, the pelleted seeds of the present invention showed better emergence dynamics, reducing not only the mean emergence time, but also the improving the uniformity of emergence, resulting in a narrower temporal distribution of emerged plants

The term “coating” as used in this document, refers to the material applied to a surface of a seed, for instance as a layer of a material around a seed. Coating includes film coating, pelleting, encapsulation, and encrusting. The coating is preferably adhered over substantially the entire surface of the seed, for example, 80% or more of the surface area of the seed, to form a layer.

In the present document the terms “encapsulation” and “pelleting” are used as synonyms.

In the present document the terms “seed capsule”, “encapsulated seed”, “seed pellet” and “pelleted seed” are used as synonyms and refer to the seed that has been coated with the seed coating composition of the present invention to achieve a spherical or quasi-spherical shape.

The term “seed” as used in this document is meant to refer to the ripened ovule of gymnosperms and angiosperms, which contains an embryo surrounded by a protective cover. In practical terms, the term “seed” comprises anything that can be planted in agriculture to produce plants, including but not limited to pelleted seeds, true seeds, plant seedlings, rootstock, and tubers or bulbs.

Unless otherwise indicated, all concentrations in this document are expressed as a % w/w.

The seed coating composition, one object of the present invention, is a material that adheres to the external surface of a seed forming a layer of material around it. Said seed coating composition comprises at least a binder and a filler.

The filler is a solid powder that constitutes the major mass and volume fraction of the seed coating composition. Said filler is selected from the group comprising, but not limited to, peat, microcrystalline cellulose, carbon, activated carbon, diatomite, bentonite, red clay, kaolin, fumed silica, expanded silica, cellulose, lignocellulose, Dried Distillers Grains (DDG), Wet Distillers Grains (WDG), and combinations thereof.

Said binder can adhere the solid filler particles to the seed and to each other. Thus, when sufficient binder and filler are added in a controlled manner and under rotational effect, a relatively thick coating can be formed around the seeds. According to the present invention, said binder is selected from the group comprising, but not limited to, poly vinyl alcohol (PVA), carboxymethyl cellulose (CMC), hydroxypropyl methylcellulose (HPMC), polyvinylpyrrolidone (PVP), xanthan gum, arabic gum, and combinations thereof. Some binders can be commercially available as solids, in that case a solution needs to be prepared in a proper solvent to obtain a binding solution with adequate concentration, viscosity and binding capacity. In a preferred embodiment, said binder or binding solution is an aqueous solution of PVA. More preferably, said binder is a 5% w/w PVA in water solution.

In an embodiment of the present invention, said filler is a combination of activated carbon and microcrystalline cellulose. In a more preferred embodiment of the invention, said activated carbon can be of vegetal origin in order to minimize the carbon footprint of the coated seeds manufacturing process.

In a preferred embodiment the seed coating composition (dry basis) comprises: from 1% to 7% PVA; between 27.5% and 60% microcrystalline cellulose; and between 37.5% and 70% activated carbon. Preferably, the seed coating composition is from 2 to 3% w/w PVA, from 33 to 50% w/w microcrystalline cellulose, and from 47 to 64% w/w activated carbon. More preferably, the seed coating composition is 2.5% w/w PVA, 38% w/w microcrystalline cellulose, and 59.5% w/w activated carbon.

In another embodiment of the present invention, said seed coating composition further comprises an agriculturally active ingredient which may protect the seed from pests, weeds, promotes germination, and provides nutrition to the seed. Said agriculturally active ingredient is selected from the group that comprises, but is not limited to, fertilizers, pesticides, fungicides, synergists, plant growth regulators, biostimulants, herbicides, and combinations thereof.

In yet another embodiment of the invention, said coating composition further comprises a dye to embellish the coating surface.

In another embodiment, said coating composition further comprises a surface modifier, wherein said surface modifier comprises components capable of modifying particular characteristics (such as gloss, roughness, or stickiness, among others) of the surface of a coated seed.

Another object of the present invention is a coated seed or an encapsulated seed which comprises at least one seed, and the seed coating composition of the present invention.

The coating process and seed coating composition of this invention may be used to coat seeds of virtually all plant species. Suitable seeds for coating using the seed coating composition and the process of the present invention include, but are not limited to those from, Beta vulgaris, Malpighia emarginata, Cichorium intybus L., Cyclanthera pedata, Vigna angularis, Agave spp., Agropyron elongatum, Agropyron scabrifolium, Agropyron cristatum, Agropyron desertorum, Agropyron intermedium, Agropyron trichoforum, Agrostis stolonifera, Physalis peruviana, Satureja montana, Artemisia absinthium, Capsicum baccatum, Pachyrhizus ahipa, Allium sativum, Allium ampeloprasum complex, Populus spp., Ocimun basilicum, Capparis Spinosa, Cynara scolymus, Cucurbita ficifolia, Medicago sativa, Lotus uliginosus, Gossypium albiflorum, Dipteryx oleifera, Phalaris canariensis, Ananas comosus, Cucurbita moschata, Angelica archangelica, Pimpinella anisum, Anthephora pubescens, Alstroemeria spp., Amaranthus hypochondriacus, Apium graveolens, Arachis pintoi, Vaccinium spp., Chrysalidocarpus Lutescens, Oryza sativa, Pisum sativum, Euterpe oleracea, Aleurites moluccana, Avena sativa, Avena byzantina, Avena sativa, Avena strigosa, Crocus sativus, Lilium longiflorum, Ziziphus Jujuba, Abelmoschus esculentus, Musa×paradisiaca, Ipomoea batatas, Adansonia digitata, Solanum melongera, Citrus bergamia, Ranunculus acris, Brachiaria ruziziensis, Urochloa brizantha, Brachiaria hibrida, Brassica forrajera rape, Brassica oleracea var. italica, Bromus valdivianus Phil., Bromus parodi, Bromus perenne, Cenchrus ciliaris, Butia capitata, Nasturtium officinale, Theobroma cacao L., Coffea arabica, Cucurbita maxima, Cucurbita argyrosperma, Berberis microphylla, Calibrachoa spp., Brassica napus, Saccharum officinarum, Cannabis sativa, Averrhoa carambola, Silybum marianum, Carthamus tinctorius, Castanea sativa, Vigna unguiculata, Cucurbita ficifolia, Hordeum vulgare, Hordeum distichum, Hordeum hexastichon, Bromus catharticus, Bromus unioloides, Bromus auleticus, Bromus inermis, Bromus unioloides var., Bromus brevis Ness, Bromus inermis, Allium cepa, Allium fistulosum L., Allium schoenoprasum, Aloysia citrodora, Secale cereale, Prunus subg. Cerasus, Cynodon dactylon, Allium ascalonicum, Salvia hispanica, Annona cherimola, Nierembergia linariifolia, Cyperus esculentus, Prunus domestica, Prunus salicina, Cymbopogon nardus, Citrus spp., Cocos nucifera L, Brassica oleracea var. gemmifera, Brassica oleracea var. botrytis, Brassica napus, Cuminum cyminum, Coriandrum sativum, Curcuma longa, Curcuma domestica, Prunus armeniaca, Phoenix dactylifera, Desmanthus acuminatus, Desmodium ascendens, Dichanthium aristatum, Digitaria sanguinalis, Dolichos lablab, Ilex dumosa, Prunus persica, Anethum graveolens, Cichorium endivia, Eragrostis curvula, Digitalis purpurea, Cichorium endivia, Asparagus officinalis, Spinacia oleracea, Stevia rebaudiana, Artemisia dracunculus, Eucalyptus spp., Phalaris aquatica, Acca sellowiana, Trigonella foenum-graecum, Festuca arundinacea, Festuca rubra, Lolium multiflorum×Festuca pratensis, Ficus spp., Photinia spp., Rubus idaeus, Arrhenatherum elatius, Fragaria spp., Cicer arietinum, Helianthus annus, Helianthus spp., Glandularia peruviana, Chloris gayana, Punica granatum, Ribes uva-crispa, Ribes nigrum, Ribes rubrum, Tecoma stans, Psidium spp. Prunus cerasus, Gypsophila spp. Vicia faba, Ficus carica, Salix×argentinensis, Foeniculum vulgare, Hyssopus officinalis, Artocarpus heterophyllus, Jatropha spp., Zingiber officinalis, Simmondsia chinensis, Brassica oleracea var. sabellica L., Diospyros kaki, Panicum coloratum, Pennisetum Purpureum×Pennisetum Typhoides, Pennisetum clandestinum, Actinidia deliciosa, Amaranthus caudatus, Fortunella spp. Handroanthus heptaphyllus, Cordia alliodora, Lavandula latifolia, Lactuca sativa, Cymbopogon citratus, Lens culinaris, Lespedeza capitata, Leucaena leucocephala, Litchi chinensis, Citrus aurantifolia, Citrus×aurantifolia, Citrus limetta, Citrus limon, Linum usitatissimum, Alisma plantago-aquatica, Lotononis bainesii, Solanum quitoense, Lupinus angustifolius, Humulus lupulus, Zea mays, Melicocca bijuga, Citrus reticulata, Manihot esculenta, Mangifera indica, Arachis hypogaea, Matricaria chamomilla, Malus domestica, Passiflora edulis, Tropaeolum tuberosum, Mecardonia procumbens, Medicago littoralis, Medicago polymorpha, Medicago scutellata, Medicago truncatula, Melilotus officinalis, Melilotus albus, Melilotus altissimus, Melilotus indicus, Cucumis melo, Gustavia superba, Mentha piperita, Panicum miliaceum, Panicum coloratum, Pennisetum glaucum, Salix viminalis, Salix caprea, Setaria italica, Brassica alba, Sinapis alba, Brassica carinata, Rubus fruticosus, Brassica juncea, Ugni molinae, Brassica campestris, Brassica rapa, Brassica napus subsp. napus, Citrus sinensis, Citrus×aurantium, Citrus×sinensis, Prunus persica var. nucipersica, Juglans regia, Macadamia integrifolia, Carya illinoinensis, Manilkara zapota, Oxalis tuberosa, Abelmoschus esculentus, Hibiscus esculentus, Olea europaea, Origanum vulgare, Cymbopogon martini, Persea americana, Panicum maximun, Panicum antidotale, Solanum tuberosum, Sechium edule, Carica papaya, Paspalum atratum, Hemarthria altissima, Pennisetum purpureum, Cynodon nlemfuensis, Megathyrsus maximus, Paspalum notatum, Axonopus catarinensis, Eragrostis curvula, Acroceras macrum, Paspalum dilatatum, Dactylis glomerata, Digitaria eriantha, Paspalum guenoarum Arechay. var. guenoarum var guenoarum, Paspalum guenoarum Arechay. var. rojasii (Hack.) Parodi var. rojasii, Dactylis glomerata, Asimina triloba, Carya illinoinensis, Minthostachys verticillata, Cucumis sativus, Pyrus communis, Pyrus pyrifolia, Petroselinum crispum, Petroselinum hortense, Petunia spp., Phalaris angusta, Phalaris aquatica, Phalaris bulbosa, Phalaris tuberinacea, Piper nigrum, Sanguisorba minor, Pistacia vera, Selenicereus undatus, Calliandra spp., Poa annua, Poa pratensis, Poa annua var. reptans, Citrus grandis, Phaseolus vulgaris, Vigna angularis, Lablab purpureus, Vigna radiata, Phaseolus lunatus, Allium. porrum, Chenopodium quinoa, Fortunella spp., Raphanus sativus, Lolium multiflorum, Lolium hybridum, Lolium perenne, Nephelium lappaceum, Beta vulgaris, Brassica oleracea, Brassica rapa pekinensis, Beta vulgaris var. rubra, Beta rubra, Ricinus communis, Brassica oleracea var. capitata, Rosa spp., Brassica oleracea var gemmifera, Ruta spp., Lolium multiflorum, Lolium perenne, Lolium persicum, Rosa sp., Salvia greggii, Citrullus vulgaris, Salix humboldtiana, Salix nigra, Salix babylonica, Salix alba, Sambucus canadensis, Lespedeza cuneata, Lespedeza cuneata, Camelina sativa, Setaria spp., Setaria viridis, Setaria sphacelata, Setaria faberi, Setaria parviflora, Macroptilium atropurpureum, Glycine max, Neonotonia wightii, sin. Glycine javanica, Sorghum bicolor, Sorghum saccharatum, Sorghum bicolor, Sorghum×drummondii, Sorghum almum, Stevia rebaudiana, Stylosanthes spp., Tagetes minuta, Nicotiana tabacum, Tamarindus indica, Citrus×tangelo, Colocasia esculenta, Euphorbia lathyris, Camellia sinensis, Tetracne spp., Lycopersicon esculentum, Thymus vulgaris, Helianthus tuberosus, Citrus medica, Lotus tenuis, Trifolium repens, Trifolium alexandrinum, Lotus corniculatus, Melilotus albus Medik, Trifolium incarnatum, Trifolium fragiferum, Trifolium resupinatum, Trifolium pratense, Lotus glaber, Lotus subbiblorus, Triticale×trigopiro, Triticum sp., Triticum spelta, Triticum durum, Triticum aestivum, Fagopyrum esculentum, Thinopyrum elongatum, xTriticosecale, Opuntia ficus-indica, Vernicia fordii, Tulipa spp., Ullucus tuberosus, Vanilla planifolia, Chrysopogon zizanioides, Vicia benghalensis, Vicia dasycarpa, Vicia faba, Vicia pannonica, Vicia villosa, Vitis vinifera, Smallanthus sonchifolius, Ilex paraguariensis, Daucus carota, Cucurbita maxima, Cucurbita maxima var. zapallito, Rubus ulmifolius, Zoysia spp., and Cucurbita pepo. In a preferred embodiment, said seed is a corn (Zea mays) seed.

In turn, the coating of said coated seed has enough mechanical strength to withstand handling without breaking and/or flaking and, once the coated seeds have been sown, it can dissolve or become soft or brittle enough to allow the seed to germinate unhindered.

In one embodiment of the invention the amount of seed coating composition and the final shape of the coated seed is adequate to obtain a pelleted seed.

In another embodiment, the amount of seed coating composition and the final shape of the coated seed is adequate to obtain an encrusted seed.

Another object of the invention is a coating process for preparing the coated seeds of the present invention. Said coating process for preparing the coated seed of the present invention can be conducted in one of the many coating machines known by a person skilled in the art to accomplish seed coating. Some well-known devices are drum coaters and rotary coaters, among others.

In a preferred embodiment of the invention, said coating machine is a rotary coater comprising a drum with a rotating plate, wherein said drum with a rotating plate consists in a fixed cylinder with a rotating bottom plate. In a more preferred embodiment, the axis of said cylinder with a bottom plate is displaced between 0° and 90° from the vertical axis. In an even more preferred embodiment, the inclination angle between the axis of said cylinder with a bottom plate and the vertical axis is 0°.

In a preferred embodiment, said coating process comprises the use of a drum with a rotating plate and comprises the steps of:
a. wetting the seeds with a liquid for at least 1 second,
b. waiting for at least 2 seconds,
c. adding the solids for at least 2 seconds,
d. waiting for at least 1 second,
e. repeating steps a. to d. until the seeds gained the desired mass and shape,
f. sieving the seeds to classify them by size,
g. drying the seeds

Wherein said liquid may comprise a liquid binder, or a solvent, or any solution of a solid binder; furthermore, said liquid may further comprise a dye and/or agriculturally active ingredients. In addition, said solids may comprise all the components of the seed coating composition that can be used in their solid state such as the filler, the binder, the agriculturally active or the dye.

In addition, said rotating plate spins at a speed between 50 and 2500 rpm.

Yet another object of the invention is a sowing process that uses the coated seeds of the present invention and comprises the following steps:
a. providing the coated seeds to the sowing machine;
b. setting the sowing machine to work with the coated seeds, taking into consideration size and shape;
c. opening a furrow in the soil;
d. inserting the coated seeds into said furrow;
e. covering the furrows with soil.

As exemplified in the present document, the coated seed of the present invention is capable of reaching emergence up to at least 5 days earlier and giving grain yields up to at least 6.8% higher than naked seed.

### EXAMPLES

### Example 1. Coating Process for Preparing Pelleted Corn Seeds

An embodiment of the coating process of present invention is described in detail below.

This process allows to obtain the pelleted seed of the present invention wherein each coated seed comprises only one corn seed and its final shape is quasi-spherical.

In this example, commercial seeds that already have a thin coating containing agriculturally active ingredients were used. The process begins wetting the seeds to be pelletized with liquid binder. Then successive layers of powdered filler are added alternating them with spraying of liquid binder.

Materials:
Washed vegetable activated carbon type CC-V1
Supplier: CarboClean
Appearance: fine sandy powder
Ashes: 11% (maximum: 12%)
pH: 7.2 (alkaline)
Iodine: 772 mg/g
Iodine (dry basis): 1052 mg/g (minimum: 1000 mg/g)
Humidity: 4.7% w/w
Bulk density: 0.51 g/cm³
Bulk density (dry basis): 0.37 g/cm³
Lot number: 42-9
Microcrystalline Cellulose Nutracel™ 102
Supplier: DFE Pharma GmbH & Co. KG

Characteristics: white or almost white fine crystalline or granulated, slightly hygroscopic powder having fluidity, odorless. Practically insoluble in water, acetone, anhydrous ethanol, toluene, diethyl ether, dilute acid and swells with 50 g/L sodium hydroxide solution.
Bulk density: 0.29 g/cm 3
Lot number: NB21D2014
PVA (Polyvinyl Alcohol)
Supplier: QINGDAO SANHUAN COLORCHEM CO., LTD.
Appearance: white (slight yellowish) Granular
Hydrolysis: 87.0˜89.0 mol %
Viscosity: 45.0˜55.0
Volatile content: 5.0%
Ash: ≤5.0 wt %
pH value: 5˜7
Purity: ≥93.5

Process:

The process is conducted in a device equipped with a vertical axis rotating bottom plate with a diameter of 350 mm, said plate is rotated at a constant speed of 300 rpm.

Per each kg of corn seed, a total of 520 g of 5% PVA solution (26 g of PVA) and 710 g of powders (434 g of activated carbon and 276 g of microcrystalline cellulose) are used.

Each application of liquid and powder are made using the same flow rate:
Liquid flow rate=13.9 g/s or 14 cm³/s.
Solid flow rate=6.1 g/s.

The coating process for preparing the pelleted seeds is conducted as follows:
a. wetting the seeds with the liquid binder for 1.5 seconds,
b. waiting 4.5 seconds,
c. adding the filler for 4.5 seconds,
d. waiting for 1.5 seconds,
e. repeating steps a. to d. until the seeds gained the desired mass,
f. sieving the seeds to classify them by size,
g. drying the seeds at 28° C. for 120 min.

The total elapsed time of the steps involving the alternating addition of binder and filler is 5 minutes.

Taking into consideration that there is between 4 and 7% of wasted material that will not form part of the pellet and that the water evaporates during drying process to obtain a final humidity of 14%, the seeds gain a mass of 33-38%. That is, from 1 kg of seeds, between 1.33 and 1.38 kg of pelleted seeds are obtained.

### Example 2. Performance Tests of Formulations with Variations in the Activated Carbon/Microcrystalline Cellulose Ratio

Objective.

The main objective of the test was to study the effect of the activated carbon/microcrystalline cellulose ratio in the corn seed coating composition on seedling development.

Procedure.

Five batches of pelleted seeds (containing 200 g of seed each batch) with different activated carbon/microcrystalline cellulose ratios, were prepared. The amounts of activated carbon and microcrystalline cellulose used in each formula are shown in Table 1. In all cases a 5% w/w PVA in water solution was used as a binder and the final percentage of PVA in the formula was 2.5% (dry basis).

TABLE 1
Prepared batches of pelleted seeds.

| Formula | Activated carbon (%) | Microcrystalline cellulose (%) |
|---|---|---|
| 1 | 17.5 | 80 |
| 2 | 37.5 | 60 |
| 3 | 59.5 | 38 |
| 4 | 70 | 27.5 |
| 5 | 80 | 17.5 |

Then, a total of 100 pelleted seeds per formula and 100 control seeds (non-pelleted seeds) were sown in the germination chamber. Sowing and subsequent analysis were conducted according to ISTA standards.

The performance evaluation was conducted by determining the following variables related to the emergence, development and vigor of the seedlings after 7 days of planting:
Germination energy (EG, 4 days after sowing).
Germination capacity (GP, 7 days after sowing).
Average root length.

### Results.

A. Pellets Preparation:

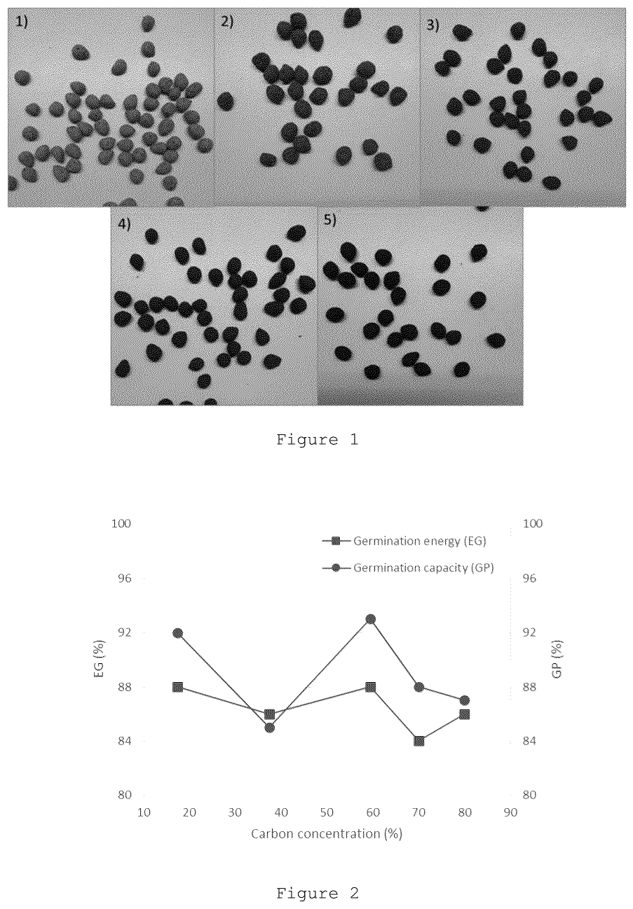

FIG. 1 shows representative photographs of pelleted seeds from each batch. As can be seen in FIG. 1, the pelleted seeds from formulas 1 and 2 present some cracks on the surface, which decreases its fluidity and increases the probability of causing breakage of the coating during bagging, storage and sowing, with the consequent material detachment. Furthermore, the presence of cracks in the coating can lead to overestimated performance results as it may facilitate water access to the seed through the openings in the coating layer. Particularly, formula number 2 presented a greater non-uniformity both in size and morphology of the pellets.

Formulas 3, 4 and 5 produced pellets with a good conformation, whitout cracks or dusting. The observations suggest that as the percentage of carbon increases, a greater surface roughness is observed.

For formulas 3 and 4 the hardness of the pelletes is intermediate, without generating appreciable mechanical impediments during the beginning of germination. Furthermore, these pellets had the best dissolution time in water, a progressive soaking of the seed was achieved.

Regarding formula 5, the pellets have a good conformation but a high hardness, which generates a mechanical impediment, partially hindering germination. The water dissolution times of the capsule are high.

B. Performance:

FIG. 2 shows the results for EG (square data points, left scale) and GP (circle data points, right scale), as a function of the activated carbon percentage in the formula. Surprisingly, formula 3 (59.5% activated carbon) presents outstanding performance.

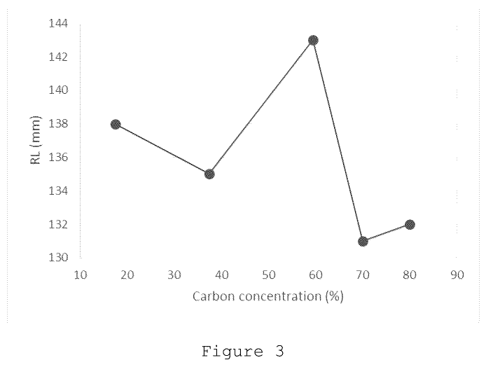

FIG. 3 displays the results of average root length (RL) as a function of the carbon percentage in the pellets. Surprisingly, formula 3 (59.5% activated carbon) presents outstanding performance.

Conclusion.

Analyzing all the variables tested, surprisingly, coated seeds of formula 3 show an extraordinary performance. This coated seed of formula 3 corresponds to the formula of 59.5% activated carbon, 38% microcrystalline cellulose and 2.5% PVA.

### Example 3. Emergence Dynamics Tests

Objective.

To evaluate seedling growth of non-pelleted and pelleted seeds with different activated carbon/microcrystalline cellulose ratios, exposed to three environmental conditions, normal condition, and thermic stress test (10° C.), and hydric stress, in order to determine variability and earlyness of emergence.

Procedure.

Batches of seeds pelleted with formulas 1 to 5 (F #1, F #2, F #3, F #4 and F #5) were prepared according to the procedure described in Example 2 and subjected to a normal test under germination chamber conditions innorder to assess their emergence dynamics. The best formula was selected, and seeds pelleted with this formula were subjected to cold and low humidity conditions in order to assess their behavior under stress. As a reference, all experiments were also carried on non-pelleted seeds.

Normal Test (Germination Chamber Conditions):

The substrate was prepared for sowing in trays, for each tray 1 kg of fine sand was weighed and mixed with 160 ml of distilled water. Subsequently, corn seeds were sown; 100 seeds (per repetition) were sown in each tray. Immediately after sowing, the trays were placed in a germination chamber at 25° C.±2 and 65% RH for 7 days.

Cold Test:

The substrate was prepared for sowing in trays, for each tray 1 kg of fine sand was weighed and mixed with 160 ml of distilled water. Then, the trays were placed for 24 h in the refrigerator (8° C.±1 and 40% RH). After this time, the trays were sown with seeds. For this purpose, 100 seeds per tray were sown and placed again in the refrigerator for 7 days at 8° C.±1. At the end of this time, the trays were placed in a germination chamber at 25° C.±2 and 65% RH for 7 days.

Hydric Stress Test:

Before starting the trial, a field capacity analysis was performed on the sand that was used as substrate) for the sowing of the pelleted seeds.

For the hydric stress test, sand was used at 15% of the field capacity (60 mL/substrate kg). One hundred seeds per formula and 100 control seeds (non-pelleted seeds) per tray were sown and placed in germination chambers at 25° C.±2 and 65% RH for 8 days.

Three repetitions of each treatment were carried out.

For all growth conditions, once the trays were placed in the germination chamber, the seeds were counted for the emergence dynamics test. For this purpose, a daily count of the emerged seedlings was made until the day of counting the germination capacity (GP).

Results:

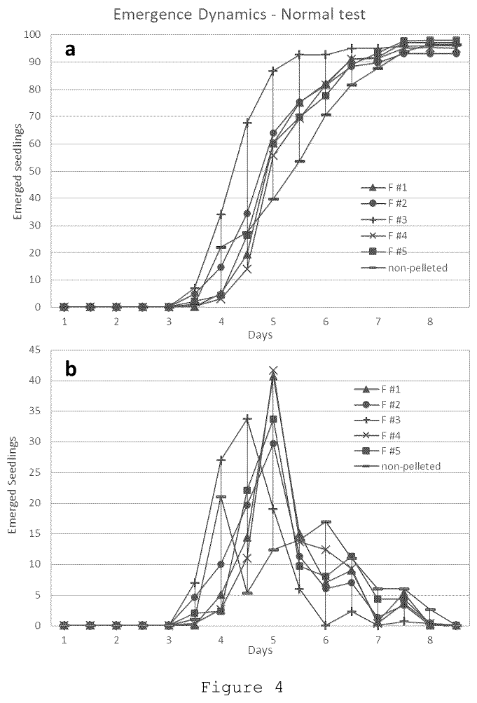

FIG. 4 clearly shows that, surprisingly, the formulation with 59.5% activated carbon and 38% microcrystalline cellulose (F #3) provides the best emergence performance under germination chamber conditions. In this vein, FIG. 4b, suggests that the emergence of all the pelleted seeds was less dispersed in time than the non pelleted ones. It can be observed that pelleted seeds with formulation F #3 emerged much earlier than the rest of the pelleted seeds.

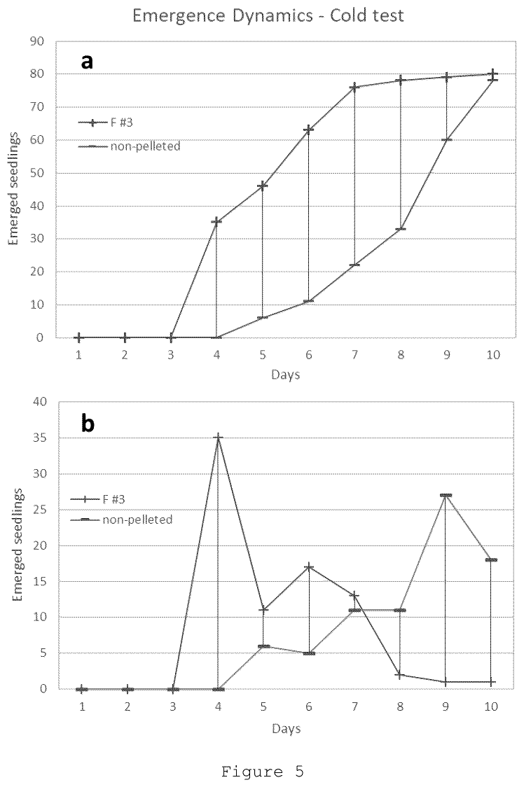

Regarding the cold test performance results (depicted in FIG. 5), after being subjected to 7 days at 8° C., the seeds that were coated with the formulation F #3 resulted much less affected that the reference seeds, exhibiting again earlier and more uniform emergence dynamics. This figure shows that in this cold test trial the emergence peak decreases in 5 days compared to the non-pelleted seed. This technical effect constitutes an enormous advantage for cold climates, and the use of the seed of the invention will reduce the time of the whole process.

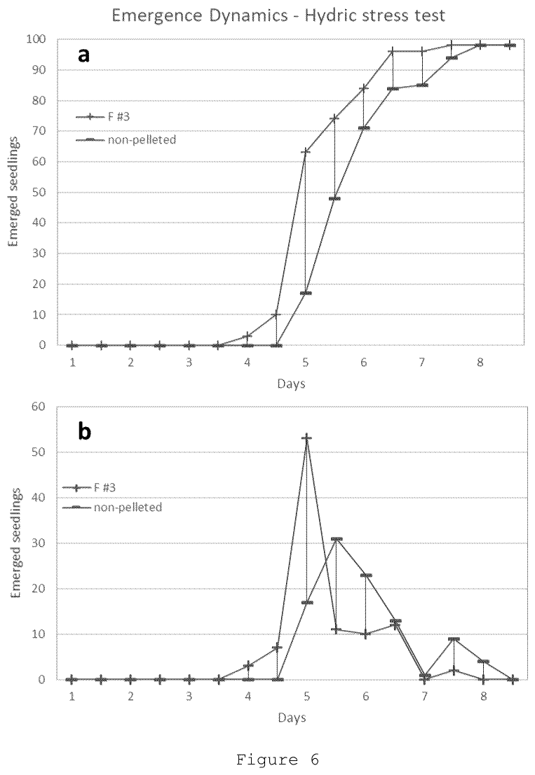

Surprisingly, after being subjected to hydric stress conditions, seeds pelleted with formulation F #3 once again demonstrated the best emergence dynamics, as can be observed from FIG. 6.

### Example 4. Cold Tests

Objective:

To characterize the behavior of pelleted (coated) seed of the invention and non-pelleted seeds under simulated low temperature soil stress conditions.

Materials and Methods:

The materials used were the following:
I. Corn seeds DK7330VT3PSPR (control).
II. Corn seeds DK7330VT3PSPR pelleted with the formula: 2.5% PVA—59.5% activated carbon—38% microcrystalline cellulose. Present invention
III. Distilled water.
IV. Plastic bags with seals.
V. Cold chamber (refrigerator between 1-10° C.)

Procedure:

A total of 6 trays were sown, three of them were sown with seeds that were pelleted with the formula 2.5% PVA—59.5% activated carbon—38% microcrystalline cellulose (trays 1, 3 and 5, with 24 seeds each) and the remaining three trays were sown with non-pelleted control seeds (trays 2, 4 and 6, also with 24 seeds each). Then, all trays were immediately exposed at a temperature of 1° C. (refrigerator temperature).

On days 5, 7 and 9 after sowing, trays 1 and 2; 3 and 4; and 5 and 6, respectively, were removed from the refrigerator and were exposed to room temperature. On the days indicated in Table 2, readings of the number of plants emerged from each tray were made. After 10 days of exposure at room temperature (reading 3), measurements of plant height and root length were made.

TABLE 2
Schedule of the cold tests.

| | | Low temp. | | | |
|---|---|---|---|---|---|
| Tray | | exposure | Room temp. exposure time (days) | | |
| Number | Seed | time (days) | Reading 1 | Reading 2 | Reading 3 |
| 1 | pelleted | 5 | 4 | 8 | 10 |
| 2 | non-pelleted | 5 | 4 | 8 | 10 |
| 3 | pelleted | 7 | 4 | 6 | 10 |
| 4 | non-pelleted | 7 | 4 | 6 | 10 |
| 5 | pelleted | 9 | 4 | 6 | 10 |
| 6 | non-pelleted | 9 | 4 | 6 | 10 |

Results and Discussion.

Table 3 shows the number of plants that emerged in the different readings (exposure times to room temperature) after 5, 7 and 9 days of exposure to low temperatures (trays 1 and 2, 3 and 4, and 5 and 6, respectively).

TABLE 3
Number of emerged plants.

| | Low temp. | | | |
|---|---|---|---|---|
| | exposure | | | |
| Tray Number | time (days) | Reading 1 | Reading 2 | Reading 3 |
| 1 | 5 | 9 | 22 | 23 |
| 2 | 5 | 1 | 16 | 16 |
| 3 | 7 | 7 | 18 | 19 |
| 4 | 7 | 0 | 5 | 18 |
| 5 | 9 | 9 | 19 | 21 |
| 6 | 9 | 3 | 15 | 20 |

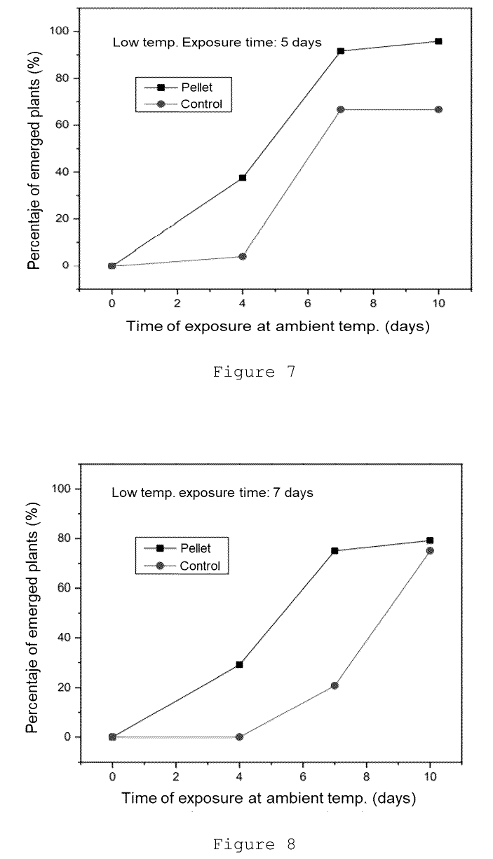

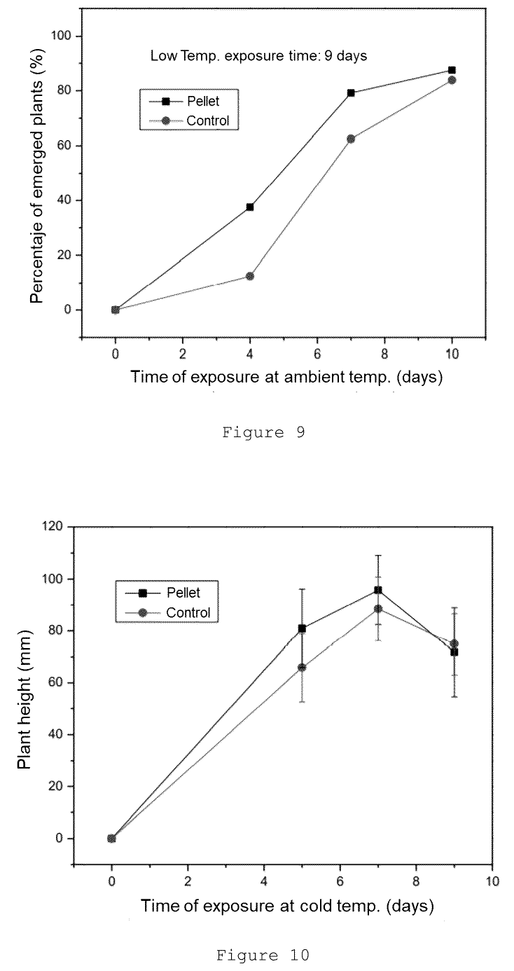

As shown in FIGS. 7 to 9 these results can be better visualized by fixing the time of exposure to low temperatures and leaving the number of plants emerged and the exposure time to room temperature as variables. In this vein, the three graphs show that the pelleted seeds germinate faster than the control seeds. The delay caused by cold stress is greater in the control seeds than in the pelleted ones.

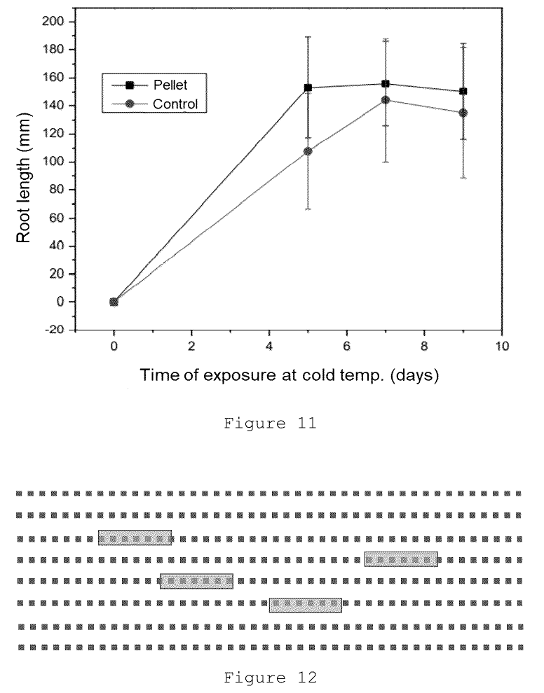

On the other hand, at the end of the 10-day trial, the average plant height (FIG. 10) and root length (FIG. 11) of each sample were measured. The error bars correspond to the standard deviation of the data set. In most cases, greater plant height and root length were observed in the pelleted seeds compared to the control ones.

Conclusions:

The plants grown from pelleted seeds exhibited notably higher development rates than that of the control seeds. These results suggest that the pelleted corn seeds prepared with this coating composition provides great protection to the seeds, reducing the stress they may suffer from sowing with low temperatures and during the germination process.

### Example 5. Germination Tests

Objective:

To determine if the seed coating composition of the pelleted seeds of the invention affects their Germination Energy (EG) and Germination Capacity (GP).

Evaluation Protocol:

In order to assess the quality of the coatings, tests were made to determine the germination energy (EG) and germination capacity (GP) of pelleted corn seeds of the invention and non-pelleted seeds as a reference.

The pelleted seeds were coated with the formula consisting of 2.5% PVA, 38% microcrystalline cellulose, and 59.5%, as example 2, formula 3.

The tests were conducted according to the procedures described in International Rules for Seed Testing (ISTA, Chapter 5). In each test 100 seeds were sown per tray, and the tests were conducted in quadruplicate. An average of the obtained values is reported in Table 4. In addition, the number of abnormal seedlings and dead seeds observed in each test is also reported.

TABLE 4
Germination test results.

| | Germination tests | | | | |
|---|---|---|---|---|---|
| | Test Date | Germination | Germination | Abnormal | Dead |
| Seed | dd/mm/yyyy | Energy | Capacity | Seedlings | Seeds |
| Pelleted | 17/01/2022 | 83 | 96 | 3 | 1 |
| Non- | 17/01/2022 | 88 | 92 | 5 | 2 |
| pelleted | | | | | |
| Pelleted | 25/02/2022 | 92 | 94 | 4 | 2 |
| Non- | 25/02/2022 | 95 | 96 | 2 | 2 |
| pelleted | | | | | |
| Pelleted | 04/03/2022 | 95 | 96 | 4 | 0 |
| Non- | 04/03/2022 | 98 | 97 | 3 | 0 |
| pelleted | | | | | |
| Pelleted | 07/04/2022 | 93 | 88 | 10 | 2 |
| Non- | 07/04/2022 | 95 | 93 | 6 | 1 |
| pelleted | | | | | |
| Pelleted | 14/04/2022 | 86 | 85 | 11 | 4 |
| Non- | 14/04/2022 | 90 | 90 | 10 | 1 |
| pelleted | | | | | |

Conclusion.

As can be seen from the results obtained, the pelleted seeds of the present invention exhibit germination characteristics similar to the control, with an expected variation from trial to trial.

### Example 6. Performance Assessment of Pelleted Corn Seeds. Campaign 2021-2022

1. Objectives
To determine the influence of pelleting on the distribution of the corn pelleted seeds of the invention in the row during sowing.
To determine the influence of pelleting on density and emergence dynamics of pelleted corn seeds.
To determine the influence of pelleting on the spatial distribution and growth of corn plants for pelleted corn seeds.
To determine the influence of pelleting on the final grain yield of the corn crop for pelleted corn seeds.

2. Evaluation Protocol

2.1. Materials and Methods

In these trials, two treatments, consisting of control seeds and pelleted corn seeds, were evaluated. The pelleted seeds were prepared using a mixture of activated carbon and microcrystalline cellulose powders in an activated carbon:microcrystalline cellulose ratio of 11:7. A 5% w/w aqueous solution of PVA was used as a binder. The liquid to powder ratio was adjusted to achieve the following coating composition (dry basis): 2.5% PVA, 38% microcrystalline cellulose, and 59.5% activated carbon.

The pellets were dried at the outlet of the pelleting machine to reach a final humidity of 13%. After this treatment, the pellets were ready for sowing.

2.1.1. Experimental Design and Methods

Field trials were made in lots in different productive regions, which were conducted by seed companies, by service providers, and by the Agriculture Department of Seed Matriz.

In these trials, “n” commercial corn seed hybrids with 2 treatments were evaluated for each of those commercial corn seed hybrids: pelleted seeds (the coated seed of the invention) and control (non-pelleted seeds).

As depicted in FIG. 12, the experimental design was a completely randomized block design with 4 repetitions for plots consisting of 4 furrows of 6 meters long (micro-plots) or strips with a paired control, where the size of each experimental unit was determined by the size of the farmer's sowing machine (number of furrows) and the length of the plot.

2.1.2. Data Collection

Data collection began at the moment of sowing and comprised three fixed determinations, with the possibility of one additional determination.

I. Emergence Time:

Emerged Plants and Visible Seedlings.

The time to make this determination in each test was calculated on the basis of a thermal model (the reading is made between 80 and 130° C. day on a base temperature of 10° C., added from the day after sowing).

In the case of the strip test design, the experimental units were 9.5 meters long. In each experimental unit the number of emerged plants was counted and registered (emerged plants were considered to be those with at least the tip of the first leaf crossing the coleoptile). Those cases where the tip of the coleoptile could be seen above the soil, but without the first leaf still visible, were also registered as visible seedlings.

II. V6-V8 Phenological stage (approximately at 240 and 330° C. day of emergence reading, with a base temperature of 8° C.):

Distance between plants and other growth and phenology parameters.

In this instance, several measurements are made on each plant in 3 linear parcels of 8 m long:
i. Distance between plants: The distance (cm) between each plant in the identified area of each experimental unit was measured. In the case of finding a double hit (2 seeds in the same position) or not being able to determine the separation between two plants, the minimum distance of 1 cm was registered.
ii. Number of expanded leaves: Considering the first true leaf to be the leaf that crosses the coleoptile (spatulate leaf), the number of expanded leaves (with visible ligule or collar) of each plant is counted and registered. In this case, the phenological stage in which each plant is found was recorded, which can be V3, V4, V5, V6, V7, or V8 according to Ritchie's scale.
iii. Plant height and diameter: The height to the ligule of the last expanded leaf (cm) and the diameter of the pseudo-stem at 2 cm above the ground were measured for each plant in each plot.

III. Harvest Time: Final Grain Yield (Kg/Hectares) at Harvest Maturity (R8).

At the R8 stage, prior to harvest, on the identified areas of each experimental unit, the number of ears was counted. For each ear, the number of kernels per row and rows per ear (yield components) were determined. In the case of strip test trials, these ears were harvested manually and the weight of 1000 grains was determined. Regardless of the harvesting method (manual or mechanical), the total mass of each experimental unit as well as the moisture content of each one of them was recorded. For the determination of the final yield, the grain weight values were adjusted to a base moisture content of 14.5%.

3. Results

I. Emergence Time:

TABLE 5
Average distance between plants, standard deviation
(σ) and variation coefficient (CV) obtained at different
locations for pelleted seeds and control seeds.

| | Pelleted Seeds | | | Control Seeds | | |
|---|---|---|---|---|---|---|
| | Average | | | Average | | |
| | distance | σ | | distance | σ | |
| Location | (cm) | (cm) | CV | (cm) | (cm) | CV |
| Villa Reducción | 32.20 | 9.53 | 29.43 | 31.13 | 10.53 | 33.30 |
| La Aguada | 38.78 | 6.52 | 16.72 | 38.08 | 12.72 | 34.15 |
| Las Higueras | 37.45 | 10.66 | 28.35 | 42.45 | 18.79 | 43.55 |
| Melincué | 27.31 | 10.26 | 37.35 | 28.58 | 12.99 | 45.42 |
| Sol de Mayo | 30.48 | 7.49 | 24.35 | 29.35 | 7.62 | 27.72 |
| AVERAGE | 33.24 | 8.89 | 27.24 | 33.92 | 12.53 | 36.83 |

Standard deviation (σ): The spatial non-uniformity of the crop is associated with the distribution of distances between plants within the planting row.

ISO 7256/1 (1984) and many experimental works and field surveys agree on using the standard deviation of the distance between plants within the planting row to determine the quality of seeding and crop implantation. In the planted crop, the standard deviation, as a plant population attribute, is an indicator of the degree of variability in the distribution of the resources available to the plants. In corn, as the deviation increases, the inequity in the distribution of resources among plants increases, and the reduction in the yield of plants with fewer resources is not compensated by the higher yield of those with more resources due to their low reproductive plasticity.

Variation coefficient (CV): It allows comparing different situations independently of the population and the spacing between rows. The CV is equal to the standard deviation (o) divided by the average distance between plants (cm) and multiplied by 100.

Table 5 displays lower average σ and CV for pelleted seeds, which proves that they provide better plantability. As will be clearly shown in the following results, this better distribution has an impact on vigor parameters and final yield.

II. V6-V8 Phenological stage

TABLE 6
Average stem diameter and standard deviation obtained at different
locations for plants grown from pelleted seeds and control seeds.

| | Pelleted Seeds | | Control Seeds | |
|---|---|---|---|---|
| | Average stem | | Average stem | |
| Location | diameter (cm) | σ (cm) | diameter (cm) | σ (cm) |
| Villa Reducción | 23.57 | 0.22 | 22.53 | 0.47 |
| La Aguada | 18.52 | 1.23 | 16.88 | 1.34 |
| Las Higueras | 27.28 | 0.15 | 26.03 | 0.33 |
| Melincué | 19.45 | 0.12 | 16.75 | 1.51 |
| Sol de Mayo | 20.52 | 0.65 | 19.15 | 0.42 |
| AVERAGE | 21.87 | 0.47 | 20.27 | 0.81 |

TABLE 7
Average plant height and standard deviation obtained at different
locations for plants grown from pelleted seeds and control seeds.

| | Pelleted Seeds | | Control Seeds | |
|---|---|---|---|---|
| | Average plant | | Average plant | |
| Location | height (cm) | σ (cm) | heigh (cm) | σ (cm) |
| Villa Reducción | 27.07 | 1.14 | 26.10 | 1.35 |
| La Aguada | 22.18 | 0.36 | 21.64 | 0.36 |
| Las Higueras | 35.48 | 2.07 | 33.14 | 0.10 |
| Melincué | 26.01 | 0.12 | 23.78 | 1.45 |
| Sol de Mayo | 23.98 | 0.80 | 23.91 | 0.41 |
| AVERAGE | 26.94 | 0.90 | 25.71 | 0.73 |

TABLE 8
Average number of leaves and standard deviation obtained at different
locations for plants grown from pelleted seeds and control seeds.

| | Pelleted Seeds | | Control Seeds | |
|---|---|---|---|---|
| | Average leave | | Average leave | |
| Location | number | σ (cm) | number | σ (cm) |
| Villa Reducción | 6.00 | 0.00 | 6.00 | 0.00 |
| La Aguada | 7.11 | 0.06 | 7.11 | 0.05 |
| Las Higueras | 6.08 | 0.00 | 6.08 | 0.00 |
| Melincué | 6.08 | 0.00 | 6.08 | 0.00 |
| AVERAGE | 6.32 | 0.02 | 6.32 | 0.01 |

From Tables 6, 7 and 8 it is possible to observe more development (evidenced by greater average stem diameter, greater average height and greater average number of leaves) in plants from pelleted seeds than in plants from control seeds.

III. Harvest Time:

TABLE 9
Yield (kg of corn/hectare) obtained in different locations
for plants generated from pelleted seeds and control seeds.

| | Pelleted Seeds | Control Seeds |
|---|---|---|
| Location | Yield (kg/ha) | Yield (kg/ha) |
| La aguada | 8711.00 | 8318.00 |
| La Ensensenada | 10018.00 | 8181.00 |
| Las Vertientes (a) | 9456.00 | 9347.00 |
| Las Vertientes (b) | 9430.00 | 9360.00 |
| AVERAGE | 9403.75 | 8801.50 |

As can be observed in Table 9, after harvesting, a 6.8% higher grain yield was obtained when sowing the pelleted seeds of the invention compared to the unpelleted seeds.

4. Conclusions

These experiments show surprisingly high performance of the pelleted (or coated) seeds of the invention. Also has been demonstrated a higher final grain yield. Finally, it should be noted that the development parameters (plant height, number of leaves and stem diameter) suggest that the plants grown from pelleted seeds are able to develop at the same rate or even faster than those grown from control seeds. This demonstrates that the coating treatment does not cause delays in phenological development in the evaluated corn seed hybrids.

1. A seed coating composition to be applied to the external surface of a seed forming a layer of material around it, wherein said seed coating composition comprises microcrystalline cellulose, activated carbon and poly vinyl alcohol (PVA).

2. The seed coating composition of claim 1, wherein said coating composition comprises from 1% to 7% PVA; between 27.5% and 60% microcrystalline cellulose; and between 37.5% and % activated carbon.

3. The seed coating composition of claim 1, wherein said coating composition comprises from 2 to 3.5% PVA; from 33% to 50% microcrystalline cellulose; and from 47% to 64% activated carbon.

4. The seed coating composition of claim 1, wherein said seed coating composition comprises 2.5% PVA, 38% microcrystalline cellulose and 59.5% activated carbon.

5. The seed coating composition of claim 1, wherein said seed coating composition further comprises an agriculturally active ingredient.

6. The seed coating composition of claim 5, wherein said agriculturally active ingredient is selected from the group consisting of fertilizers, pesticides, fungicides, synergists, plant growth regulators, biostimulants, herbicides, and combinations thereof.

7. A coated seed suitable for its use in sowing techniques, wherein said coated seed comprises at least one seed and the seed coating composition of claim 1.

8. The coated seed of claim 7, wherein said coated seed comprises corn (Zea mays) seeds.

9. The coated seed of claim 7, wherein it comprises pelleted seeds and encrusted seeds.

10. A coating process for preparing coated seeds of claim 7 in a drum with a rotating plate, comprising:
a. wetting the coated seeds with a liquid for at least 1 second,
b. waiting for at least 2 seconds,
c. adding the solids for at least 2 seconds,
d. waiting for at least 1 second,
e. repeating steps a. to d. until the seeds gain a desired mass and shape,
f. sieving the seeds to classify them by size,
g. drying the seeds.

11. The coating process of claim 10, wherein said liquid comprises a 5% in water PVA solution.

12. The coating process of claim 10, wherein said solid comprises a mixture of microcrystalline cellulose and activated carbon in a microcrystalline cellulose:activated carbon mass ratio selected from the range from 0.3 to 1.6.

13. The coating process for preparing a coated seed in a drum with a rotating plate of claim 10, wherein said plate spins at a speed between 50 and 2500 rpm.

14. The coating process for preparing a coated seed in a drum with a rotating plate of claim 10, wherein the inclination angle between the axis of said cylinder with a bottom plate and the vertical axis is from 0° to 90°.

15. A sowing process that uses the coated seeds of claim 7, comprising:
a. providing the coated seeds to a sowing machine;
b. setting the sowing machine to work with the coated seeds, taking into consideration size and shape;
c. opening a furrow in the soil;
d. inserting the coated seeds into said furrow;
e. covering the furrow with soil.
